(19) United States
(12) Patent Application Publication
(10) Pub. No.: US 2007/0075603 A1
(43) Pub. Date: Apr. 5, 2007

(54) Labyrinthine end disk rotor

(76) Inventor: Richard M. Whiddon, Simpsonville, SC (US)

Correspondence Address: ROCKWELL AUTOMATION, INC./(AT), ATTENTION: SUSAN M. DONAHUE, 1201 SOUTH SECOND STREET, MILWAUKEE, WI, 53204, US

(21) Appl. No.: 11/241,019

(22) Filed: Sep. 30, 2005

(51) Int. Cl. H02K 17/16

(52) U.S. Cl. 310/211

(57) ABSTRACT

A rotor configured to receive a cast internal conductive structure is disclosed. The rotor includes a rotor core having a plurality of rotor slots extending through the rotor core. The rotor also includes a plurality of slotted end members adjacent one another and axially aligned with the rotor core. One end member is radially positioned such that the slots of the end member are offset with respect to another end member. A rotating machine having such a rotor and a method of manufacture are also disclosed.

### BACKGROUND

The present invention relates generally to the field of electrical rotating machines, such as motors, generators, or the like. More particularly, the present techniques concern the rotor assemblies of such rotating machines.

Electrical rotating machines, such as electric motors, generators, and other similar devices, are quite common and may be found in diverse industrial, commercial, and consumer settings. These machines are produced in a variety of mechanical and electrical configurations. The configuration of these devices may depend upon the intended application, the operating environment, the available power source, or other similar factors. In general, these devices include a rotor surrounded at least partially by a stator.

For instance, one common design of electrical rotating machine is the induction motor, which is used in numerous and diverse applications. In industry, such motors are employed to drive various kinds of machinery, such as pumps, conveyors, compressors, fans and so forth, to mention only a few. Conventional alternating current (AC) electric induction motors may be constructed for single-phase or multiple-phase power and are typically designed to operate at predetermined speeds or revolutions per minute (rpm), such as 3600 rpm, 1800 rpm, 1200 rpm, and so forth.

Induction motors typically employ a rotor assembly positioned within a stator assembly that includes a slotted core in which groups of coil windings are installed. More particularly, the rotor assemblies of such motors often include a core formed of a series of magnetically conductive laminations arranged to form a lamination stack capped at each end by electrically conductive end rings. Additionally, typical rotors include a series of conductors that are formed of a nonmagnetic, electrically conductive material and that extend through the rotor core. These conductors are electrically coupled to one another via the end rings, thereby forming one or more closed electrical pathways.

In the case of alternating current motors, applying alternating current power to the stator windings induces a sympathetic current in the rotor, specifically in the conductors. The electromagnetic interaction between the rotor and the stator cause the rotor to rotate within the stator. The rotational speed of the rotor is typically a function of the frequency of the alternating current power input and of the motor design (i.e., the number of poles defined by the stator windings). A rotor shaft extending through the motor housing may take advantage of this induced rotation and translates the rotational movement into a driving force for a given piece of machinery. That is, rotation of the shaft drives the machine to which it is coupled.

In some applications, design parameters for such motors call for relatively high rotor rotation rates, i.e., a high number of revolutions per minute (rpm). By way of example, a rotor within an induction motor may operate at rates as high as 20,000 rpm or beyond. Based on the diameter of the rotor, operation at such rpm translates into relatively high surface speeds on the rotor. Again by way of example, these rotor surface speeds can reach or exceed values of 175 meters per second (mps). During operation, particularly during high-speed operation, the centripetal force produced by the rotation may strain various components of the rotor assembly. For example, if not properly accounted for, the centripetal force in the end ring may cause plastic deformation of the end ring, which can lead to an unbalanced rotor that prematurely malfunctions. Further, at higher speeds, the rotational forces may cause a traditional end ring to peel away from the lamination stack or, in the case of a porous end ring material, cause voids in the end ring to collapse and unbalance the rotor. Moreover, these rotational forces may, over time, negatively affect the mechanical integrity of the rotor to such an extent that failure of the motor occurs. Undeniably, loss of performance and motor failure are events that can lead to unwanted costs and delays.

There exists a need, therefore, for a method and apparatus for improved rotor construction and integrity.

### BRIEF DESCRIPTION

In accordance with certain embodiments, the present techniques provide a rotor for an electric machine having a slotted rotor core, a first slotted or perforated end member, and a second slotted or perforated end member. The first and second end members are axially aligned with the rotor core on one side thereof. The first and second end members are radially staggered with respect to one another such that the slots of the first and second end members cooperate with the rotor slots to define a plurality of rotor channels extending through the rotor. In some embodiments, the rotor includes an internal conductive structure cast in the plurality of rotor channels. In accordance with further embodiments, the present techniques also provide a rotating machine having such a rotor and a stator core configured to receive the rotor.

Further, the present techniques provide an exemplary method for manufacturing a rotor having a cast internal conductive structure. The exemplary method includes aligning a plurality of rotor laminations to form a rotor core having a plurality of conduits. The method also includes axially aligning perforated end members with the rotor core in a staggered fashion to form channels through the rotor core and perforated end members. Further, the method includes casting a conductive system in the channels.

Additionally, other embodiments of the present techniques include a rotor for an electric machine. The rotor includes a rotor core having a plurality of rotor slots and at least one end member having a plurality of end slots. The end member or members are positioned with respect to the rotor core to form a contiguous volume for receiving a cast rotor bar and end ring conductive structure.

### DRAWINGS

FIG. 1 is a perspective view of an electric motor illustrating the various functional components of the motor, including a rotor and a stator, in accordance with certain aspects of the present techniques;

FIG. 2 is a perspective view of an electric rotor assembly having an internal conductive system in accordance with one embodiment of the present techniques;

FIG. 3 is a partial sectional view of certain elements of the rotor assembly provided in FIG. 2, including an internal conductive structure in accordance with one embodiment of the present techniques;

FIG. 4 is a perspective view of the internal conductive structure of FIG. 3, which is illustrated independent of the rotor assembly to more clearly depict certain features of the conductive structure;

FIG. 5 is an exploded perspective view of certain elements of a rotor assembly in accordance with an embodiment of the present techniques;

FIG. 6 is an elevational view of one end of the assemblage of the rotor elements depicted in FIG. 5, which more clearly illustrates the staggered rotation of the end plates of the assembly;

FIG. 7 is a perspective view of the assembled rotor elements of FIG. 5 having a conductive system cast within the rotor elements in accordance with certain aspects of the present techniques;

FIG. 8 is a perspective view of the rotor assembly of FIG. 7 mounted on a shaft, illustrating one end of the assembly following the removal of excess material of the conductive system in accordance with certain aspects of the present techniques; and

FIG. 9 is a flowchart representative of an exemplary method for manufacturing a rotor in accordance with one embodiment of the present techniques.

### DETAILED DESCRIPTION

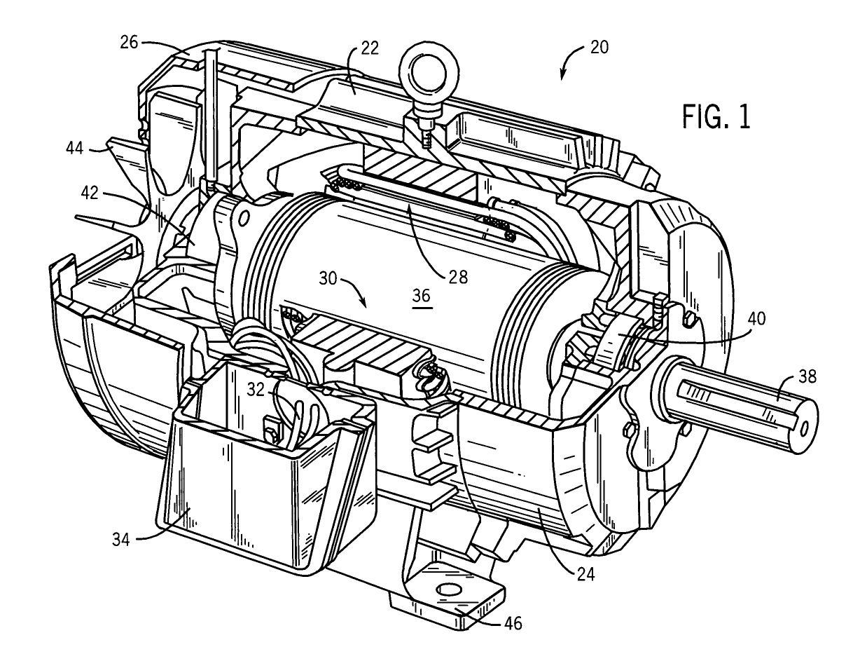

Turning now to the drawings, and referring first to FIG. 1, an electric motor is shown and designated generally by the reference numeral 20. In the embodiment illustrated in FIG. 1, motor 20 is an induction motor housed in an enclosure. Accordingly, motor 20 includes a frame 22 open at front and rear ends and capped by a front end cap 24 and a rear end cap 26. The frame 22, front end cap 24, and rear end cap 26 form a protective shell, or housing, for a stator assembly 28 and a rotor assembly 30. Stator windings are electrically interconnected to form groups, and the groups are, in turn, interconnected. The windings are further coupled to terminal leads 32. The terminal leads 32 are used to electrically connect the stator windings to an external power cable (not shown) coupled to a source of electrical power. Energizing the stator windings produces a magnetic field that induces rotation of the rotor assembly 30. The electrical connection between the terminal leads and the power cable is housed within a conduit box 34.

In the embodiment illustrated, rotor assembly 30 comprises a rotor 36 supported on a rotary shaft 38. As will be appreciated by those skilled in the art, shaft 38 is configured for coupling to a driven machine element (not shown), for transmitting torque to the machine element. Rotor 36 and shaft 38 are supported for rotation within frame 22 by a front bearing set 40 and a rear bearing set 42 carried by front end cap 24 and rear end cap 26, respectively. In the illustrated embodiment of electric motor 20, a cooling fan 44 is supported for rotation on shaft 38 to promote convective heat transfer through the frame 22. The frame 22 generally includes features permitting it to be mounted in a desired application, such as integral mounting feet 46. As will be appreciated by those skilled in the art, however, a wide variety of rotor configurations may be envisaged in motors that may employ the techniques outlined herein. Similarly, the present technique may be applied to a variety of motor types having different frame designs, mounting and cooling styles, and so forth.

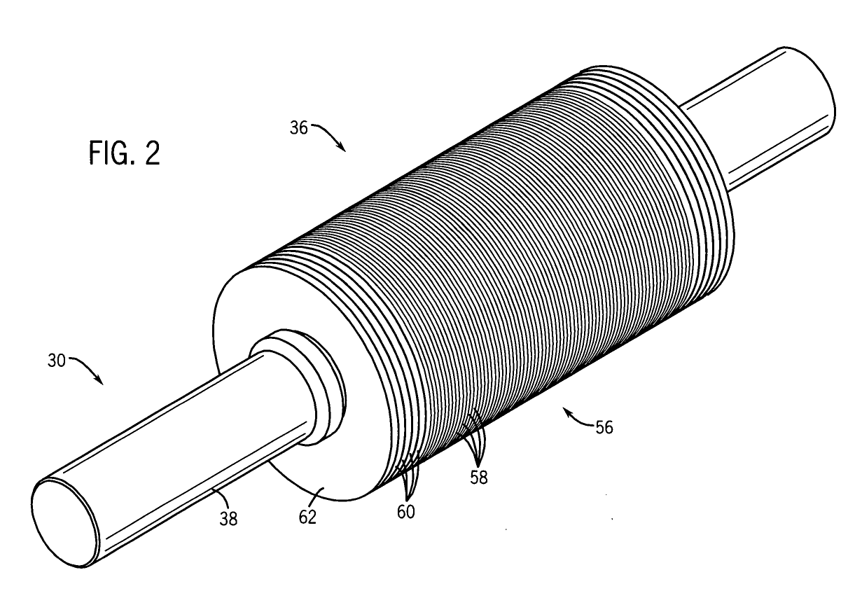

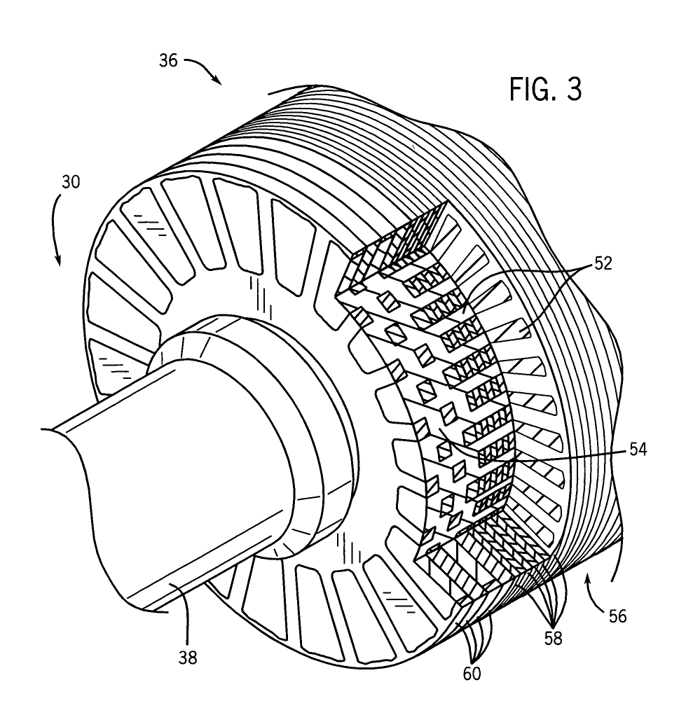

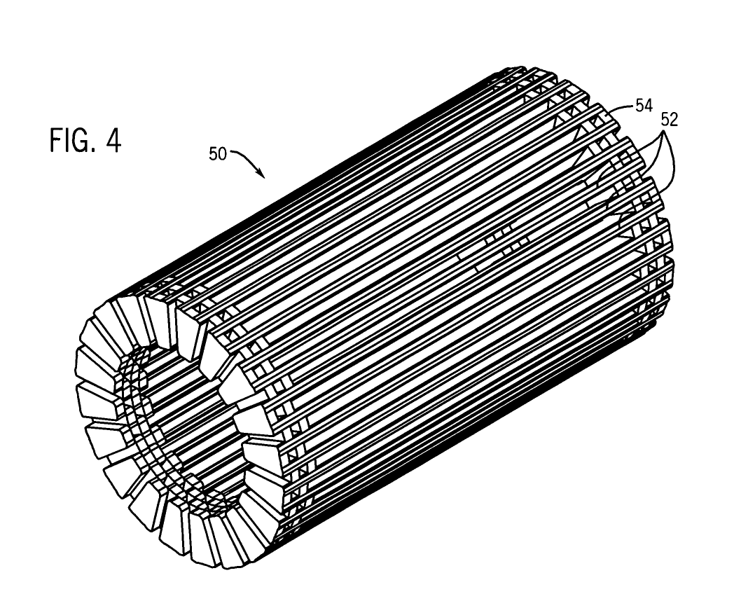

Additional features of rotor assembly 30 are illustrated in FIG. 2. Rotor 36 of the assembly includes a lamination stack 56 having a plurality of laminations 58. As will be appreciated, laminations 58 may be formed of high-strength electrical steel or another appropriate material through various manufacture processes, including stamping. Rotor 36 also includes perforated end plates 60, the perforations of which cooperate with apertures formed in laminations 58 to define channels for containing an internal conductive structure 50, as discussed below with respect to FIGS. 3 and 4. In the presently illustrated embodiment, rotor 36 also includes solid end plates 62 on the front and rear ends of rotor 36. In certain embodiments, the perforated end plates 60 and solid end plates 62 are made from high strength non-magnetic steel. However, any or all of end plates 60 and 62 could be formed from other suitable materials in alternative embodiments. Further, each perforated end plate 60 may have a one-piece design, such as illustrated in the present figure, or may be formed from a plurality of perforated laminations. As will be appreciated, the various elements of rotor 36 may be coupled to shaft 38 to rotate with the shaft during operation.

A partial front sectional view of rotor 36 is depicted in FIG. 3 to more clearly illustrate certain features in accordance with the present techniques. Notably, front solid end plate 62 and portions of perforated end plates 60 and several laminations 58 are removed to illustrate the internal conductive structure of rotor 36. For the sake of additional clarity, internal conductive structure 50 is also illustrated in FIG. 4 as removed from rotor 36. As described in greater detail below, each of laminations 58 includes a plurality of apertures that cooperate with the perforations of end plates 60 to define a contiguous volume for receiving a conductive structure 50, which may be cast in the channels in accordance with the present techniques.

Conductive structure 50 includes conductor bars 52, which extend through laminations 58, and a labyrinthine, honey-combed, or layered conductive end ring 54. In certain embodiments, conductive structure 50 is made of aluminum. In alternative embodiments, however, other suitable conductive materials may be used. In this embedded arrangement, the laminations 58 and perforated end rings 60 constrain (i.e., surround and contain) conductive structure 50, preventing radial deformation during high-speed operation. As will be appreciated, such deformation is undesirable as it causes the rotor to become unbalanced, thereby limiting the efficiency, productivity, and longevity of the rotor. During high-speed operation, axial deformation of conductive structure 50 may be prevented through use of solid end plate 62. However, as will be appreciated, solid end plates 62 may be omitted in certain embodiments, such as those in which rotational and surface speeds are capable of threatening the integrity of the conductive structure. As will be appreciated, the desirability of solid end rings will be determined by a number of factors, including speed, strength and creep properties of the casting material, max rotor temperature, and the like.

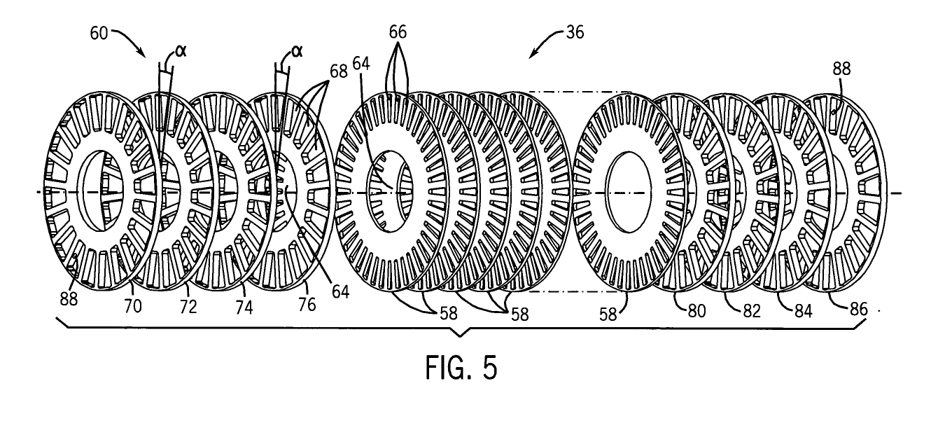

An exploded perspective view of certain elements of rotor 36 is provided in FIG. 5 to more clearly illustrate the arrangement of the laminations 58 and perforated end plates 60. As will be appreciated, laminations 58 and each end plate 60 include a central aperture 64 configured to receive a shaft, such as shaft 38. As noted above, laminations 58 have a plurality of apertures 66 that define a plurality of conduits through lamination stack 60 once assembled. Perforated end plates 70, 72, 74, and 76 each include a plurality of apertures or perforations 68 that cooperate with apertures 66 to form channels through the assembled rotor 36.

Notably, perforated end plates 60 are staggered with respect to one another to define a labyrinthine passage within the end plates. Particularly, although the perforated end plates 60 and laminations 58 are axially aligned with each other, perforated end plate 72 is rotated or radially displaced by an angle, denoted by the Greek letter alpha in the figures, with respect to perforated end plates 70 and 74. Similarly, perforated end plate 76 is also rotated or radially displaced by the same angle with respect to perforated end plates 70 and 74. This staggered arrangement of perforated end plates 60 results in a labyrinthine or honey-combed passageway that extends through the assembled plates. Perforated end plates 80, 82, 84, and 86 are similarly staggered. Once assembled, the labyrinthine passages within end plates 70-76 and 80-86 cooperate with the conduits formed by the plurality of laminations 58 to define channels for containing internal conductive structure 50. Although the presently illustrated embodiment includes four perforated end rings 60 on each end of the lamination stack 58, it should be noted that a different number of perforated end rings are used in certain embodiments. Particularly, the present techniques are applicable through use of any number of perforated end rings that are arranged to form a labyrinthine passage through the perforated end rings.

Additionally, one or more of the perforated end plates may include a retaining feature, such as notch 88, which facilitates securing of a perforated end plate to a cast conductive structure 50. In the presently illustrated embodiment, notch 88 extends through an interstice to receive casting material therein. Other retaining features are also envisaged, including notches of other configurations, including elongated notches which would provide greater structural reinforcement; one or more pins extending from a perforated end plate into the aperture to cooperate with conductive structure 50, or other similar arrangements. Further, mating features may be provided in the perforated plates 60 to facilitate coupling of the plates to one another.

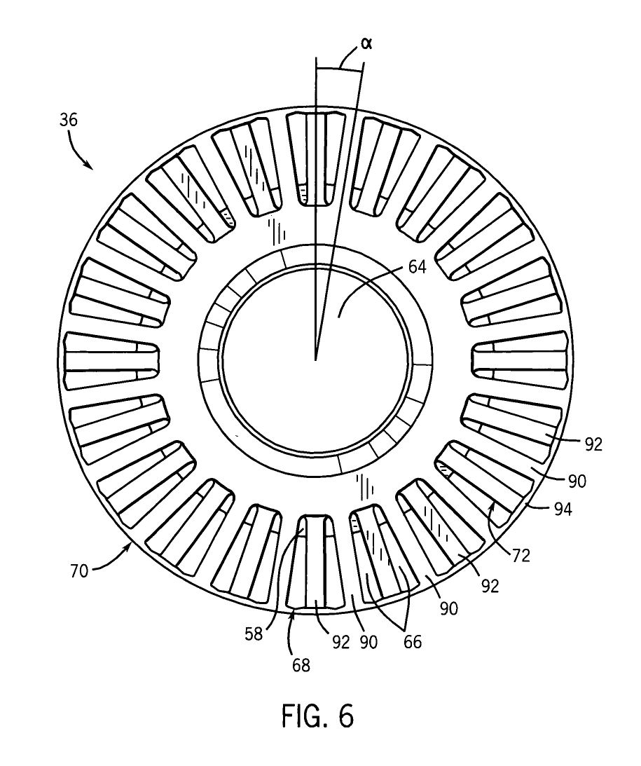

The staggering of perforated end plates 60 may be more clearly understood with reference to FIG. 6, which is a front elevational view of the assembly provided in FIG. 5. In the present embodiment, laminations 58 are configured such that two apertures 66 may be aligned with each perforation 68 of a perforated end plate 60. Particularly, perforated end plate 70 includes a plurality of interstices 90 that extend between perforations 68 from the center of the end plate to a rim or bridge 94. Perforated end plate 72 is similarly configured with interstices 92, but rotated at the angle indicated in FIG. 6 with respect to perforated end plate 70, as noted above. Thus, in the present illustration, the perforations of end plate 70 are aligned with the interstices 92 of end plate 72. Conversely, the perforations of end plate 72 are aligned with the interstices 90 of end plate 70. In the present embodiment, the other end plates 60, i.e. end plates 74, 76, and 80-86, are staggered in a similar manner.

It should also be noted that the bridge 94 of each perforated end plate 60 is configured to prevent radial deformation of the portion of an internal conductive structure disposed within the perforations 68. However, other configurations of bridge 94 may be employed in full accordance with the present techniques. For example, the radial width of bridges 94 may be increased or decreased based on the forces expected to act on the conductive structure and end plates. Further, perforated end plates having bridges 94 of different widths with respect to one another may be employed if desirable.

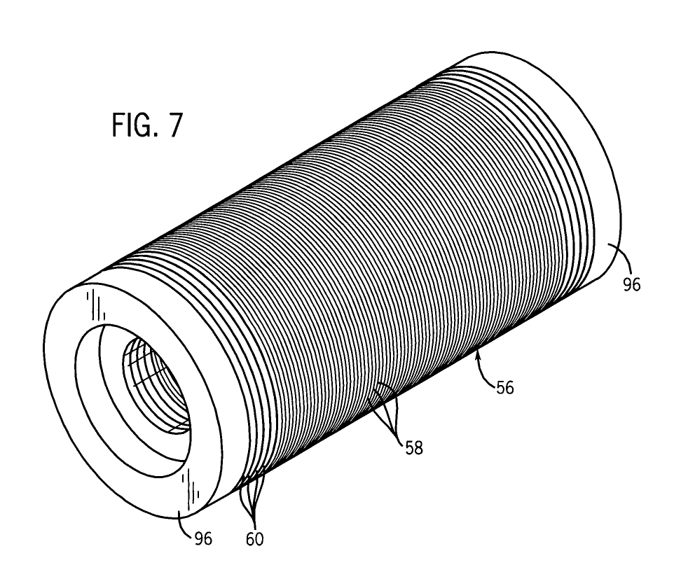

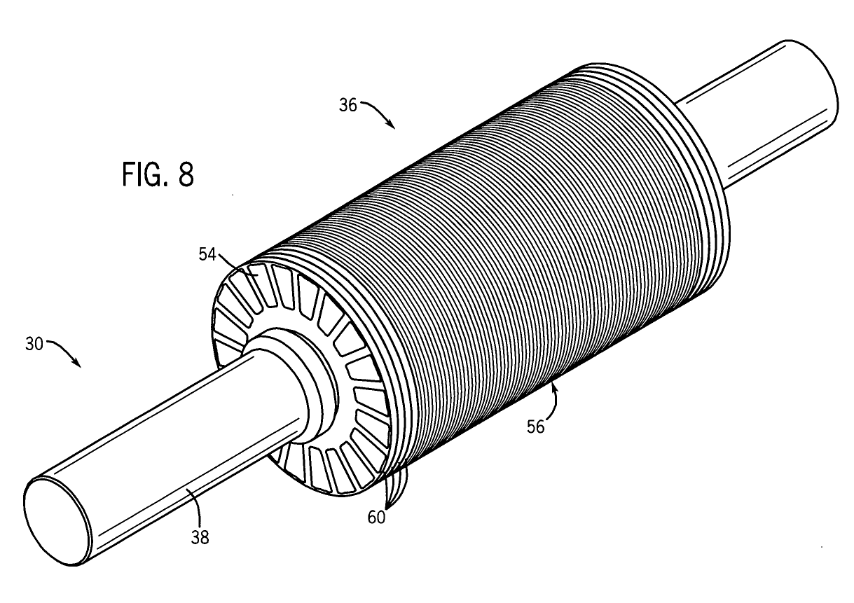

Once the laminations 58 and perforated end plates 60 are positioned, a conductive material 96 may be cast through the internal channels as illustrated in FIG. 7. As may be appreciated, such a casting process can leave excess conductive material 96 on the ends of the assembly. As may also be appreciated, the outermost portions of material 96 will generally be more porous than the material further within the assembly. Accordingly, the excess material 96 may be removed, such as through machining. This removes the more porous material, leaving an internal conductive structure 50 having substantially fewer voids, as illustrated in FIG. 8. The rotor may be mounted to a shaft before removing any excess material, allowing the excess material to be machined off during a turning process, or after removal of the excess material. A hot isostatic step may be performed prior to machining to further reduce the porosity of material 96 in a manner known in the art.

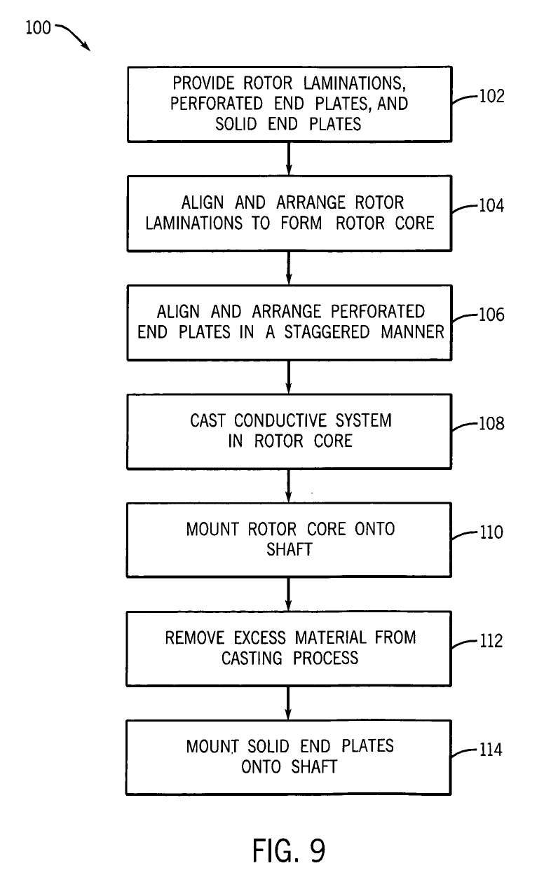

With FIGS. 1-8 in mind, FIG. 9 diagrammatically illustrates an exemplary method 100 for manufacturing a rotor in accordance with an embodiment of the present techniques. The exemplary method includes the act of providing rotor laminations and perforated end plates, as is represented by block 102. In one embodiment of the present method, solid end plates may also be provided. As will be appreciated, these rotor laminations and end plates may be provided through purchase, manufacture, or any other suitable manner. By way of example, rotor laminations may be fabricated via a stamping process, in which a pattern is stamped on a thin sheet of a metal blank. Additionally, as discussed above, perforated end plates may be formed as one integral piece or may be formed of multiple pieces, such as from a plurality of laminations.

The exemplary method 100 also includes aligning and arranging rotor laminations to form a rotor core, as indicated in block 104, and aligning and staggering perforated end plates, as indicated in 106. As noted above, the rotor laminations and perforated end plates are axially aligned, with successive perforated plates staggered with respect to one another. Once assembled, a conductive material is cast in the rotor, as indicated in block 108. Any suitable casting material may be used, such as aluminum, copper, or the like. Once the casting material has cooled the rotor may be mounted on a shaft, as indicated in block 110, and excess casting material may be removed, as indicated in block 112. The excess material may be removed in any suitable manner, such as machining. Finally, solid end plates may be mounted on the shaft, as indicated in block 114. This exemplary process results in a rotor having a structurally reinforced conductive structure that may be manufactured efficiently while providing increased reliability and longevity.

This arrangement provides increased structural integrity to reduce or prevent various failures and problems outlined above. Particularly, because the perforated end rings are mounted to the shaft, these end rings are mechanically constrained from peeling away from the rest of the rotor. Further, as will be appreciated, the interstices of the perforated end plates prevent the outer bridge of the plates from going out of round. As will be further appreciated, the outer rim or bridge of each end plate prevents radial expansion of the internal conductive structure. In some embodiments, the labyrinthine end ring configuration provides an end ring having a conductive portion coupled to, and exhibiting electrical properties substantially identical to, the conductor bars in the rotor lamination stack, while providing enhanced structural support as described above.

It should be noted that the electrical and mechanical structures described above may be adapted in a number of ways to provide the benefits offered by the invention. For example, an internal contiguous volume that defines parallel, circumferentially spaced slots and conductive end “rings” may be defined by a single end ring member with perforations dimensioned and spaced such as to join the rotor slot volumes. Similarly, more than one such ring may be used, as described above. While it may be preferable that the end rings be self-similar or even identical (e.g., to reduce the number of different parts), differently configured rings may be employed to define the desired contiguous volume that will ultimately receive the cast conductive material to form the internal structure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A rotor for an electric machine, the rotor comprising:
a rotor core having a plurality of rotor slots extending through the rotor core;
a first end member axially aligned with and disposed at one end of the rotor core, the first end member having a first plurality of end slots; and
a second end member disposed adjacent the first end member, the second end member having a second plurality of end slots cooperative with the rotor slots and the first plurality of end slots to define a plurality of rotor channels extending through the rotor core and the first and second end members, wherein the second end member is axially aligned with the rotor core and radially positioned such that the second plurality of end slots is radially offset with respect to the first plurality of end slots.

2. The rotor of claim 1, comprising an internal conductive structure cast in the plurality of rotor channels.

3. The rotor of claim 2, wherein the internal conductive structure comprises aluminum.

4. The rotor of claim 2, wherein the conductive structure comprises a plurality of conductor bars electrically coupled to one another.

5. The rotor of claim 1, comprising an end ring including the first and second members and a conductive material within the first and second pluralities of slots.

6. The rotor of claim 5, wherein at least one of the first or second end members includes a retaining feature configured to cooperate with the conductive material to prevent relative motion between the respective end member and the conductive material.

7. The rotor of claim 1, comprising a third end member disposed adjacent the second end member, the third end member having a third plurality of end slots that cooperate with the rotor slots and the first and second pluralities of end slots to define a plurality of rotor channels extending through the rotor core and the first, second, and third end members, wherein the third end member is axially aligned with the first and second end members and radially aligned with the first end member.

8. The rotor of claim 7, comprising a fourth end member disposed adjacent the third end member, the fourth end member having a fourth plurality of end slots cooperative with the rotor slots and the first, second, and third pluralities of end slots to define a plurality of rotor channels extending through the rotor core and the first, second, third, and fourth end members, wherein the fourth end member is axially aligned with the first, second, and third end members and radially aligned with the second end member.

9. The rotor of claim 1, comprising
a third end member disposed at one end of the rotor core opposite the first end member, the third end member having a third plurality of end slots; and
a fourth end member disposed adjacent the third end member, the fourth end member having a fourth plurality of end slots cooperative with the rotor slots and the first, second, and third pluralities of end slots to define a plurality of rotor channels extending through the rotor core and the end members, wherein the fourth end member is axially aligned with the third end member and radially displaced such that the fourth plurality of end slots is radially offset with respect to the third plurality of end slots.

10. A rotating machine comprising:
a rotor comprising:
a rotor core having a plurality of rotor slots extending through the rotor core;
a first end member axially aligned with and disposed at one end of the rotor core, the first end member having a first plurality of end slots;
a second end member disposed adjacent the first end member, the second end member having a second plurality of end slots cooperative with the rotor slots and the first plurality of end slots to define a plurality of rotor channels extending through the rotor core and the first and second end members, wherein the second end member is axially aligned with the rotor core and radially displaced such that the second plurality of end slots is radially offset with respect to the first plurality of end slots; and
an internal conductive structure cast in the plurality of rotor channels; and
a stator core having a central aperture configured to receive the rotor and a plurality of slots disposed circumferentially about the central aperture and configured to receive a plurality of stator windings.

11. The rotating machine of claim 10, wherein the internal conductive structure includes a labyrinthine conductive structure cast within the first and second end slots.

12. The rotating machine claim of claim 10, wherein the internal conductive structure includes a plurality of conductor bars.

13. The rotating machine of claim 10, wherein the internal conductive structure comprises aluminum.

14. The rotating machine of claim 10, wherein the rotor comprises a plurality of perforated end members opposite the rotor core from the first and second end members.

15. A method of manufacturing a rotor, the method comprising the acts of:
aligning a plurality of rotor laminations to form a rotor core, the rotor core including a plurality of conduits defined by apertures in the rotor laminations;
aligning first and second end members with the rotor core, the first and second end members each having a plurality of perforations, wherein the first and second end members are axially aligned with the rotor core and arranged in a staggered fashion adjacent one another such that perforations of the first and second end members are arranged with respect to one another to form channels through the rotor core and first and second end members, the channels defined by the staggered perforations and the conduits; and
casting a conductive system in the channels, the conductive system including a plurality of conductor bars joined to a labyrinthine conductive end ring.

16. The method of claim 15, wherein casting a conductive system in the channels comprises casting aluminum in the channels.

17. The method of claim 15, comprising removing excess casting material formed on an end of a rotor assembly including the rotor core and first and second end members during the casting process.

18. The method of claim 15, comprising mounting the rotor core on a shaft.

19. The method of claim 18, comprising mounting an end plate to the shaft proximate the first and second end members.

20. The method of claim 15, comprising aligning third and fourth end members, each having a plurality of perforations, with the rotor core and the first and second end members in a staggered manner such that the perforations of the third and fourth end members cooperate with the perforations of the first and second end members and the conduits of the rotor core to form channels that extend through each of the end members and the rotor core.

21. The method of claim 20, wherein the third and fourth end members are positioned opposite the rotor core from the first and second end members.

22. The method of claim 20, wherein the first, second, third, and fourth end members are positioned on the same side of the rotor core.

23. The method of claim 22, further comprising aligning a plurality of end members with the rotor core on a side of the rotor core opposite the first, second, third, and fourth end members, each end member of the plurality of end members having a plurality of perforations, wherein the plurality of end members is axially aligned with the rotor core and arranged in a staggered fashion such that perforations of the plurality of end members and the conduits form channels through the rotor core, the plurality of end members, and the first, second, third, and fourth end members.

24. The method of claim 23, wherein the plurality of end members comprises four end members.

25. A rotor for an electric machine, the rotor comprising:
a rotor core having a plurality of rotor slots extending through the rotor core; and
at least one end member having a plurality of end slots, the at least one end member positioned with respect to the rotor core such that the rotor slots and the end slots cooperate to form a contiguous volume for receiving a cast rotor bar and end ring conductive structure, the contiguous volume including more than one rotor slot.

26. The rotor of claim 25, comprising a plurality of end members having a plurality of end slots, the plurality of end members positioned with respect to the rotor core and each other such that the rotor slots and the end slots cooperate to form a contiguous volume for receiving a cast rotor bar and end ring conductive structure, the contiguous volume including more than one rotor slot.

27. The rotor of claim 26, wherein the plurality of end members are disposed on a single side of the rotor core.

28. The rotor of claim 26, wherein the plurality of end members comprise a first subset of end members positioned on a first side of the rotor core and a second subset of end members positioned on a second side of the rotor core opposite the first side.

29. The rotor of claim 25, comprising the cast rotor bar and end ring conductive structure.

30. The rotor of claim 29, wherein the cast rotor bar and end ring conductive structure comprises aluminum.

31. A rotor for an electric machine, the rotor comprising:
a rotor core having a plurality of rotor slots extending through the rotor core;
at least one end member having a plurality of end slots, the at least one end member positioned with respect to the rotor core such that the rotor slots and the end slots cooperate to form a contiguous volume, the contiguous volume defining a rotor bar and end ring volume including more than one rotor slot; and
a conductive material substantially filling the contiguous volume.

32. The rotor of claim 31, wherein the conductive material is substantially radially surrounded by portions of the core and portions of the at least one end member.
